(19) United States
(12) Patent Application Publication
(10) Pub. No.: US 2016/0227285 A1
(43) Pub. Date: Aug. 4, 2016

(54) BROWSING VIDEOS BY SEARCHING MULTIPLE USER COMMENTS AND OVERLAYING THOSE INTO THE CONTENT

(71) Applicant: THOMSON LICENSING, Issy Les Moulineaux (FR)

(72) Inventor: Neil VOSS, Norwalk, CT (US)

(21) Appl. No.: 15/022,006

(22) PCT Filed: Aug. 27, 2014
(86) PCT No.: PCT/US2014/052870

§ 371 Date: Mar. 15, 2016

Related U.S. Application Data
(60) Provisional application No. 62/003,281, filed on May 27, 2014.
(60) Provisional application No. 61/878,245, filed on Sep. 16, 2013.

(51) Int. Cl. H04N 21/4788; H04N 21/858; H04N 21/84; H04N 21/262; H04N 21/239; H04N 21/431

(52) U.S. Cl. CPC H04N 21/4788; H04N 21/2393; H04N 21/4312; H04N 21/84; H04N 21/262; H04N 21/858

(57) ABSTRACT

A method and apparatus for users to leave media rich comments on media content. The clients/media-server system allows users to attach comments to a media in order to create a multiuser generated content that is relevant to a user viewing of the content. The media is inserted at particular media content times. Media and Comments may be of any type (test, audio, video, . . . ). Querying a video by searching the comments from multiple users (“commentators”). Displaying the overlay of the video combined with the comments. The method further comprising at least a second comment wherein a first comment is displayed with a higher priority (e.g. larger) than the second comment based on the relationship (family, close friend, . . . ) between the commentators and the present user viewing the annotated media. Keywords: Video-annotated video. Video blogging.

This application claims priority from U.S. Provisional Application No. 61/878,245 filed Sep. 16, 2013 and U.S. Provisional Application No. 62/003,281 filed May 27, 2014, the entireties of which are hereby incorporated by reference.

### BACKGROUND OF THE INVENTION

Portable electronic devices are becoming more ubiquitous. These devices, such as mobile phones, music players, cameras, tablets and the like often contain a combination of devices, thus rendering carrying multiple objects redundant. For example, current touch screen mobile phones, such as the Apple iPhone or Samsung Galaxy android phone contain video and still cameras, global positioning navigation system, internet browser, text and telephone, video and music player, and more. These devices are often enabled an multiple networks, such as wifi, wired, and cellular, such as 3G, to transmit and received data.

The quality of secondary features in portable electronics has been constantly improving. For example, early “camera phones” consisted of low resolution sensors with fixed focus lenses and no flash. Today, many mobile phones include full high definition video capabilities, editing and filtering tools, as well as high definition displays. With these improved capabilities, many users are using these devices as their primary photography devices. Hence, there is a demand for even more improved performance and professional grade embedded photography tools. Additionally, users wish to share their content with others in more ways that just printed photographs and do so easily. These methods of sharing may include email, text, or social media websites, such as Facebook™, Twitter™, YouTube™ and the like. Users may upload content to a video storage site or a social media site, such as YouTube™.

Using social media, viewers often become commentators and provide comments or feedback concerning the media being shared by other contributors. In fact, this feedback is a primary driver in making social media desirable. However, comments on video media are often difficult to understand after a viewer has watched a long video, as the comment may concern only one portion of the video or a particular aspect of a video scene. Thus, the media provider may be confused as to what the commenter is referring to. Further, if many comments are provided, comments more desirable to the media provider may be lost in the mass of less desirable comments. Thus, it is desirable to overcome these problems with current cameras embedded in mobile electronic devices.

### SUMMARY OF THE INVENTION

A method and apparatus for facilitating users to leave media rich comments on media content. The system allows users to attach video content to a video to create a multiuser generated content that is relevant to a viewer of the content. The media can be inserted at particular times within a media content. The viewer may also sort content by provider in order to customize a viewing experience more relevant to the particular viewer.

In accordance with an aspect of the present invention, a method comprising the steps of receiving a request for a first media content, searching for a first comment related to said first media content, combining said first media content and said first comment into a combined media content, and transmitting said combined media content.

In accordance with another aspect of the present invention, a method comprising the steps of generating a request for a first media content in response to a user input, receiving said first media content, searching for a first comment, wherein said first comment is related to said first media content, receiving said first comment, combining said first media content and said first comment into a combined media content, and generating a signal containing said combined media content.

In accordance with yet another aspect of the present invention, an apparatus comprising an interface for generating a control signal in response to a user input, a processor for generating a request for a first media content in response to a user input, generating a request for a first comment, wherein said first comment is related to said first media content, and for combining said first media content and said first comment into a combined media content, said processor further operative to generating a signal containing said combined media content, and a transmitter for transmitting said request for said first media content and said request for said first comment, and an input for receiving said first media content and said first comment.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an exemplary embodiment of mobile electronic device;

FIG. 2 shows an exemplary mobile device display having an active display according to the present invention;

FIG. 3 shows an exemplary process for image stabilization and reframing in accordance with the present disclosure;

FIG. 4 shows an exemplary mobile device display having a capture initialization according to the present invention;

FIG. 5 shows an exemplary process for initiating an image or video capture in accordance with the present disclosure;

FIG. 6 shows an exemplary display device for displaying media comments on media content according to the present invention;

FIG. 7 shows an another exemplary display device for displaying media comments on media content according to the present invention;

FIG. 8 shows an exemplary timeline for displaying media comments on media content in accordance with the present disclosure;

FIG. 9 shows an exemplary process for generating media comments in media content in accordance with the present disclosure;

FIG. 10 shows another exemplary process for generating media comments in media content in accordance with the present disclosure;

### DETAILED DESCRIPTION OF THE PREFERRED EMBODIMENT

The exemplifications set out herein illustrate preferred embodiments of the invention, and such exemplifications are not to be construed as limiting the scope of the invention in any manner.

The method and system for media comments on media content permits users to leave media rich comments on media content. Users viewing artistic video content or the like are restricted in the manner they leave feedback, such as a follow up video or a text comment. Users may not be interested what others they do not know think of a content. Searching through comments to find what friends think may be laborious. Other systems, such as YouTube™ allow a user to link a follow up commentary video, or write a text comment. The system has no preference for prioritizing reviewers. When users view creative content, they may want to contribute to the creative endeavor in a creative way. Often text comments are just compiled with spam and irrelevant comments to the average user. The inventive system permits users to attach video content to a video to create a multiuser generated content that is relevant to a viewer of the content. The comments may include text embedded in the video which moves with the content. It may be video spliced into the original content or playing in preview mode during certain relevant times during playback of the original content. The comments may be restricted to one or 2 degrees of separation from the viewer. For example, only comments from immediate friends or friends of friends are shown to a viewer. Comments and video comments may be elected to be shown on the second playback loop of the video. For example, the video plays a first time in the original format and then plays a second time with the comments and video segments displayed. There may be a second level of comments replayed on subsequent playing of the video. For example, first playback original, second playback first degree of friends of the viewer, third playback loop second degree of friends to the viewer, fourth playback loop, most popular comments added to the video playback. The video may comprise buckets of saved comments, where each bucket may relate to a degree of friendship or some other comment entity, such as men or women, professional vs. personal, members of like collaborative groups, etc. In this manner, collections of videos are collaborated on by other users. Users may insert content if allowed or add content where all content is stored in a common bucket and played seamlessly to a viewer.

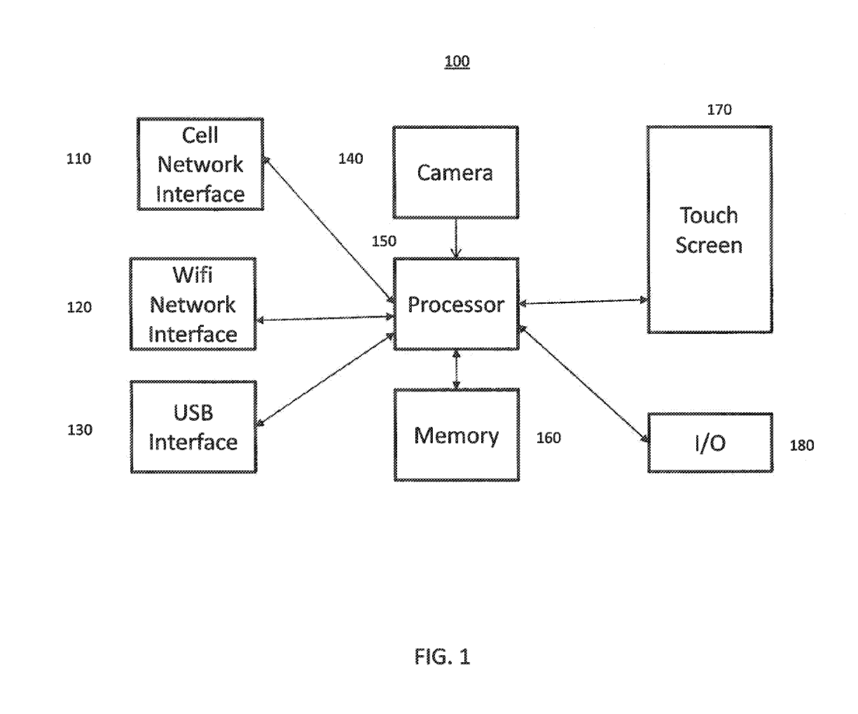

Referring to FIG. 1, a block diagram of an exemplary embodiment of mobile electronic device is shown. While the depicted mobile electronic device is a mobile phone 100, the invention may equally be implemented on any number of devices, such as music players, cameras, tablets, global positioning navigation systems etc. A mobile phone typically includes the ability to send and receive phone calls and text messages, interface with the Internet either through the cellular network or a local wireless network, take pictures and videos, play back audio and video content, and run applications such as word processing, programs, or video games. Many mobile phones include GPS and also include a touch screen panel as part of the user interface.

The mobile phone includes a main processor 150 that is coupled to each of the other major components. The main processor, or processors, routes the information between the various components, such as the network interfaces, camera 140, touch screen 170, and other input/output I/O interfaces 180. The main processor 150 also processes audio and video content for play back either directly on the device or on an external device through the audio/video interface. The main processor 150 is operative to control the various sub devices, such as the camera 140, touch screen 170, and the USB interface 130. The main processor 150 is further operative to execute subroutines in the mobile phone used to manipulate data similar to a computer. For example, the main processor may be used to manipulate image files after a photo has been taken by the camera function 140. These manipulations may include cropping, compression, color and brightness adjustment, and the like.

The cell network interface 110 is controlled by the main processor 150 and is used to receive and transmit information over a cellular wireless network. This information may be encoded in various formats, such as time division multiple access (TDMA), code division multiple access (CDMA) or Orthogonal frequency-division multiplexing (OFDM). Information is transmitted and received from the device trough a cell network interface 110. The interface may consist of multiple antennas encoders, demodulators and the like used to encode and decode information into the appropriate formats for transmission. The cell network interface 110 may be used to facilitate voice or text transmissions, or transmit and receive information from the internet. This information may include video, audio, and or images.

The wireless network interface 120, or wifi network interface, is used to transmit and receive information over a wifi network. This information can be encoded in various formats according to different wifi standards, such as 802.11g, 802.11b, 802.11ac and the like. The interface may consist of multiple antennas encoders, demodulators and the like used to encode and decode information into the appropriate formats for transmission and decode information for demodulation. The wifi network interface 120 may be used to facilitate voice or text transmissions, or transmit and receive information from the internet. This information may include video, audio, and or images.

The universal serial bus (USB) interface 130 is used to transmit and receive information over a wired like, typically to a computer or other USB enabled device. The USB interface 120 can be used to transmit and receive information, connect to the internet, transmit and receive voice and text calls. Additionally, this wired link may be used to connect the USB enabled device to another network using the mobile devices cell network interface 110 or the wifi network interface 120. The USB interface 120 can be used by the main processor 150 to send and receive configuration information to a computer.

A memory 160, or storage device, may be coupled to the main processor 150. The memory 160 may be used for storing specific information related to operation of the mobile device and needed by the main processor 150. The memory 160 may be used for storing audio, video, photos, or other data stored and retrieved by a user.

The input output (I/O) interface 180, includes buttons, a speaker/microphone for use with phone calls, audio recording and playback, or voice activation control. The mobile device may include a touch screen 170 coupled to the main processor 150 through a touch screen controller. The touch screen 170 may be either a single touch or multi touch screen using one or more of a capacitive and resistive touch sensor. The smartphone may also include additional user controls such as but not limited to an on/off button, an activation button, volume controls, ringer controls, and a multi-button keypad or keyboard

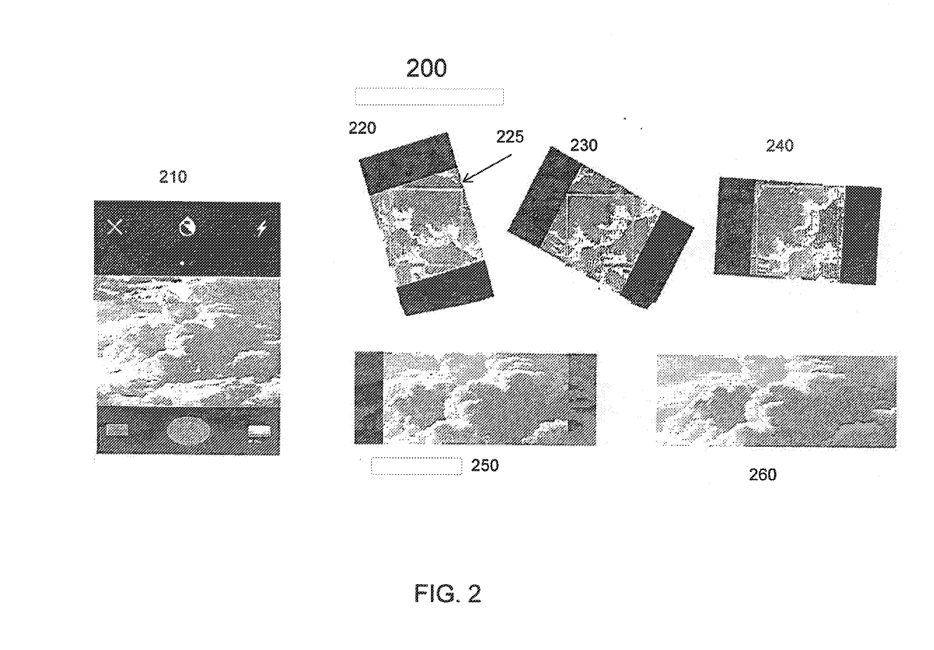

Turning now to FIG. 2 an exemplary mobile device display having an active display 200 according to the present invention is shown. The exemplary mobile device application is operative for allowing a user to record in any framing and freely rotate their device while shooting, visualizing the final output in an overlay on the device's viewfinder during shooting and ultimately correcting for their orientation in the final output.

According to the exemplary embodiment, when a user begins shooting their current orientation is taken into account and the vector of gravity based on the device's sensors is used to register a horizon. For each possible orientation, such as portrait 210, where the device's screen and related optical sensor is taller than wide, or landscape 250, where the device's screen and related optical sensor is wider than tall, an optimal target aspect ratio is chosen. An inset rectangle 225 is inscribed within the overall sensor that is best-fit to the maximum boundaries of the sensor given the desired optimal aspect ratio for the given (current) orientation. The boundaries of the sensor are slightly padded in order to provide ‘breathing room’ for correction. This inset rectangle 225 is transformed to compensate for rotation 220, 230, 240 by essentially rotating in the inverse of the device's own rotation, which is sampled from the device's integrated gyroscope. The transformed inner rectangle 225 is inscribed optimally inside the maximum available bounds of the overall sensor minus the padding. Depending on the device's current most orientation, the dimensions of the transformed inner rectangle 225 are adjusted to interpolate between the two optimal aspect ratios, relative to the amount of rotation.

For example, if the optimal aspect ratio selected for portrait orientation was square (1:1) and the optimal aspect ratio selected for landscape orientation was wide (16:9), the inscribed rectangle would interpolate optimally between 1:1 and 16:9 as it is rotated from one orientation to another. The inscribed rectangle is sampled and then transformed to fit an optimal output dimension. For example, if the optimal output dimension is 4:3 and the sampled rectangle is 1:1, the sampled rectangle would either be aspect filled (fully filling the 1:1 area optically, cropping data as necessary) or aspect fit (fully fitting inside the 1:1 area optically, blacking out any unused area with ‘letter boxing’ or ‘pillar boxing’. In the end the result is a fixed aspect asset where the content framing adjusts based on the dynamically provided aspect ratio during correction. So for example a 16:9 video comprised of 1:1 to 16:9 content would oscillate between being optically filled 260 (during 16:9 portions) and fit with pillar boxing 250 (during 1:1 portions).

Additional refinements whereby the total aggregate of all movement is considered and weighed into the selection of optimal output aspect ratio are in place. For example, if a user records a video that is ‘mostly landscape’ with a minority of portrait content, the output format will be a landscape aspect ratio (pillar boxing the portrait segments). If a user records a video that is mostly portrait the opposite applies (the video will be portrait and fill the output optically, cropping any landscape content that falls outside the bounds of the output rectangle).

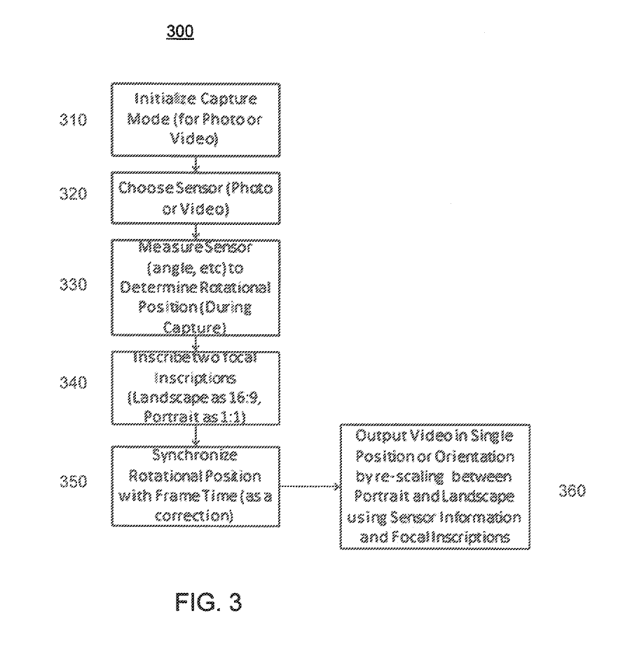

Referring now to FIG. 3, an exemplary process for image stabilization and reframing 300 in accordance with the present disclosure is shown. The system is initialized in response to the capture mode of the camera being initiated. This initialization may be initiated according to a hardware or software button, or in response to another control signal generated in response to a user action. Once the capture mode of the device is initiated, the mobile device sensor 320 is chosen in response to user selections. User selections may be made through a setting on the touch screen device, through a menu system, or in response to how the button is actuated. For example, a button that is pushed once may select a photo sensor, while a button that is held down continuously may indicate a video sensor. Additionally, holding a button for a predetermined time, such as 3 seconds, may indicate that a video has been selected and video recording on the mobile device will continue until the button is actuated a second time.

Once the appropriate capture sensor is selected, the system then requests a measurement from a rotational sensor 320. The rotational sensor may be a gyroscope, accelerometer, axis orientation sensor, light sensor or the like, which is used to determine a horizontal and/or vertical indication of the position of the mobile device. The measurement sensor may send periodic measurements to the controlling processor thereby continuously indicating the vertical and/or horizontal orientation of the mobile device. Thus, as the device is rotated, the controlling processor can continuously update the display and save the video or image in a way which has a continuous consistent horizon.

After the rotational sensor has returned an indication of the vertical and/or horizontal orientation of the mobile device, the mobile device depicts an inset rectangle on the display indicating the captured orientation of the video or image 340. As the mobile device is rotated, the system processor continuously synchronizes inset rectangle with the rotational measurement received from the rotational sensor 350. They user may optionally indicate a preferred final video or image ration, such as 1:1, 9:16, 16:9, or any ratio decided by the user. The system may also store user selections for different ratios according to orientation of the mobile device. For example, the user may indicate a 1:1 ratio for video recorded in the vertical orientation, but a 16:9 ratio for video recorded in the horizontal orientation. In this instance, the system may continuously or incrementally rescale video 360 as the mobile device is rotated. Thus a video may start out with a 1:1 orientation, but could gradually be rescaled to end in a 16:9 orientation in response to a user rotating from a vertical to horizontal orientation while filming. Optionally, a user may indicate that the beginning or ending orientation determines the final ratio of the video.

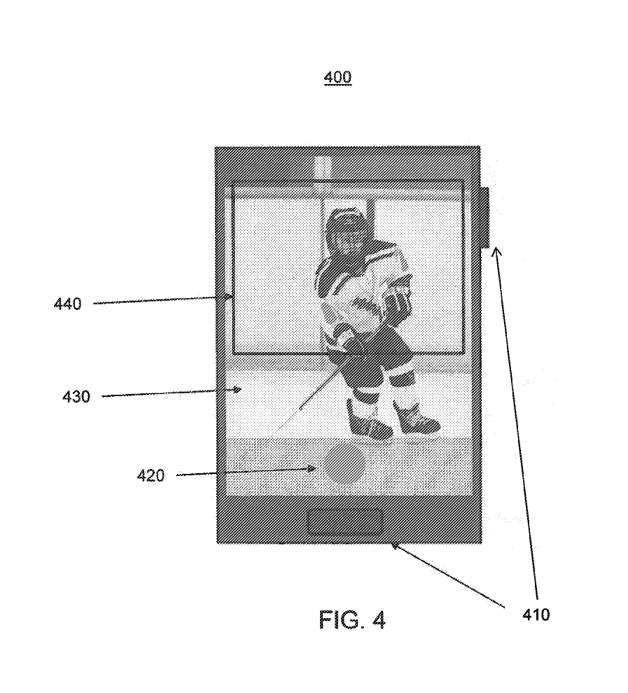

Turning now to FIG. 4, an exemplary mobile device display having a capture initialization 400 according to the present invention is shown. An exemplary mobile device is show depicting a touch tone display for capturing images or video. According to an aspect of the present invention, the capture mode of the exemplary device may be initiated in response to a number of actions. Any of hardware buttons 410 of the mobile device may be depressed to initiate the capture sequence. Alternatively, a software button 420 may be activated through the touch screen to initiate the capture sequence. The software button 420 may be overlaid on the image 430 displayed on the touch screen. The image 430 acts as a viewfinder indicating the current image being captured by the image sensor. An inscribed rectangle 440 as described previous may also be overlaid on the image to indicate an aspect ratio of the image or video be captured.

The capture sequence may be activated by pushing and holding a button, such as a software button or hardware button, and deactivated by releasing the button. Alternatively, the capture sequence may be activated by pushing a button once and then deactivated by pushing the button a second time. The video recording mode may be initiated without regard to the timer through different gesture, without regard to the timer. This different gesture might include double tapping the button, holding the button and swiping to one side, or the like.

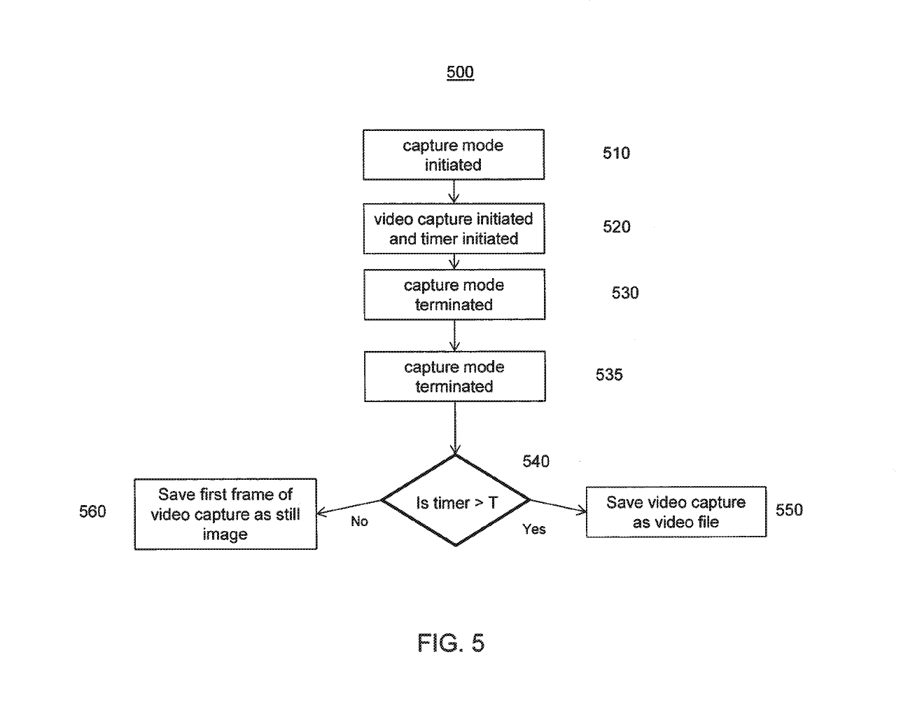

Referring now to FIG. 5, an exemplary process for initiating an image or video capture 500 in accordance with the present disclosure is shown. Once the imaging software has been initiated, the system waits for an indication to initiate image capture. Once the image capture indication has been received by the main processor 510, the device begins to save the data sent from the image sensor 520. In addition, the system initiates a timer. The system then continues to capture data from the image sensor as video data. In response to a second indication from the capture indication, indicating that capture has been ceased 530, the system stops saving data from the image sensor and stops the timer.

The system then compares the timer value to a predetermined time threshold 540. The predetermined time threshold may be a default value determined by the software provider, such as 1 second for example, or it may be a configurable setting determined by a user. If the timer value is less than the predetermined threshold 540, the system determines that a still image was desired and saves the first frame of the video capture as a still image in a still image format, such as JPEG or the like 560. The system may optionally choose another frame as the still image. If the timer value is greater than the predetermined threshold 540, the system determines that a video capture was desired. The system then saves the capture data as a video file in a video file format, such as mpeg or the like 550. The system then may then return to the initialization mode, waiting for the capture mode to be initiated again. If the mobile device is equipped with different sensors for still image capture and video capture, the system may optionally save a still image from the still image sensor and start saving capture data from the video image sensor. When the timer value is compared to the predetermined time threshold, the desired data is saved, while the unwanted data is not saved. For example, if the timer value exceeds the threshold time value, the video data is saved and the image data is discarded.

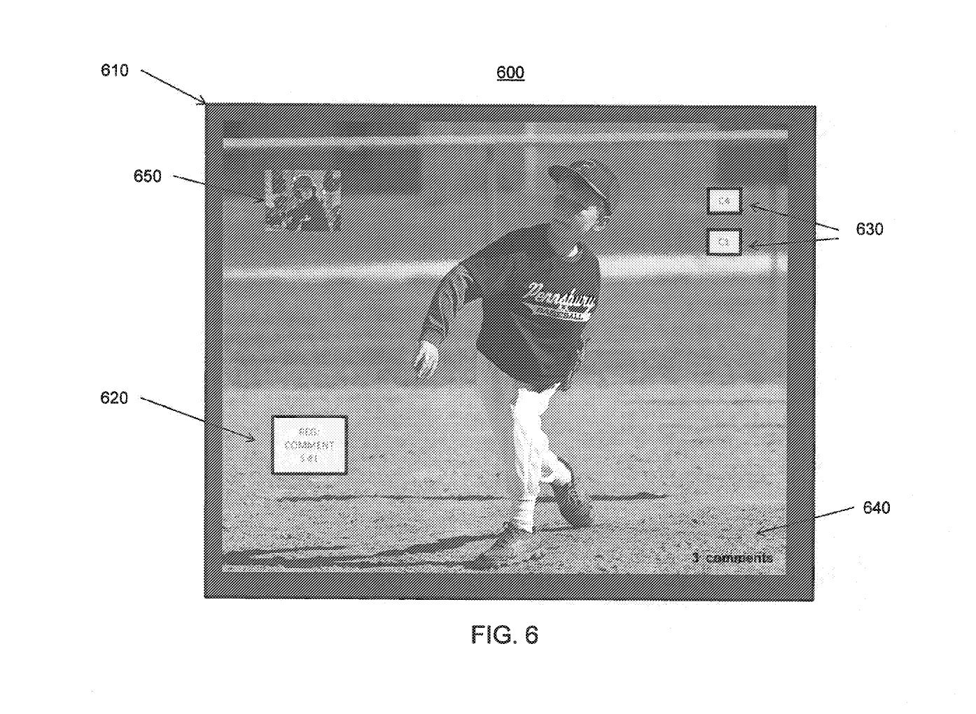

Referring now to FIG. 6, an exemplary display device having displaying media comments on media content 600 according to the present invention is shown. In this exemplary embodiment, a display device 610 is shown, such as computer monitor or television which is capable of playing back video or other streaming media. Alternatively the display device may be a mobile phone, tablet, or like device. For illustrative purposes, a frame of a video is shown. As can be seen on the frame of the video, comment indicators 620, 630, 640 650 are shown superimposed on the video. These comment indicators may be shown in accordance with a commentator's direction. For example, a commentator may wish to comment on a particular portion of a video, such as in this example, a particular pitch by a baseball player. The commentator may be able to indicate the start time of the comment indicator, a stop time, a duration, and/or a particular position of the media comment on the media content.

The comments may be text comments superimposed on the original media content 620, may be links to additional media content 650, or may be additional media comments played in full or in preview mode simultaneously with the original media content. For example, a commentator may elect to create a response video to the original media content or may record an audio comment in response to the original media content. A viewer of the media content with the comments superimposed may elect to activate one of the comments, by clicking or the like, and in response to the activation may be presented with the video response content. After the video response content is played, the viewer may be returned to the point in the original media content when the comment was activated, thereby continuing viewing of the original media content. Alternatively, media comments may be an audio comment that is played in place of the original media content audio. Thus, a commentator may be heard speaking over a portion of the original media video. A video comment may be enabled to be played in the smaller comment window with comment audio activated or not activated. Thus, when a viewer is watching the original content, a picture in picture (PIP) view of the media comment is played in the smaller comment window.

It may become confusing or overly time consuming from a viewers standpoint when a large number of comments are received for a particular media content, such as a video. For example, if media comments are integrated into the original media content, a viewer may lose track of the original content as too many media comments are being played, or the view of the original media comment is obscured. A viewer may not wish to view comments from everyone, but may wish to view or see only comments from certain groups of contributors in order to view more personally relevant comments. At some times, a viewer may be interested in comments from one group, such as family and friends, but at another time, the viewer may wish to view only comments from contributors to common collaborative groups. Thus, the present system includes a user interface permitting a user to select and prioritize groups in order to view desired comments at a desired time.

Attributes of the media comment indicators may be scaled or weighted based on the relationship with the user. For example, if the commentator is a close friend, the indicator 620, 650 is more prominent, if a secondary friend, or friend of friend, the comment indicator 630 may be a little smaller. Unknown commentators, or members of a certain group, may be shown even smaller, or as a numerical value superimposed on the video 640. Activating the numerical value comment may bring the viewer to a list of comments by the commentators in that group. Commentators may be made more prominent based on relationship to the viewer, relationship to the original content creator, commenter membership in a particular group, or based on a social rating system, such as likes, positive references, or the like.

As the number of comments increases, for example, comments from close friends, the scale of the indicator may also be changed. For example, if a single media comment has been provided by a close friend, the comment indicator may be displayed as a comment indicator covering 3% of the original media content frame size. When a predetermined number of media comments have been received by close friends, such as 4 media comments, the size of each of the comment indicators are decreased to 1% of the original media content frame size. Lower priority comments are also scaled accordingly, with possibly some comment indicators being removed, and a numerical indicator 640 being incremented.

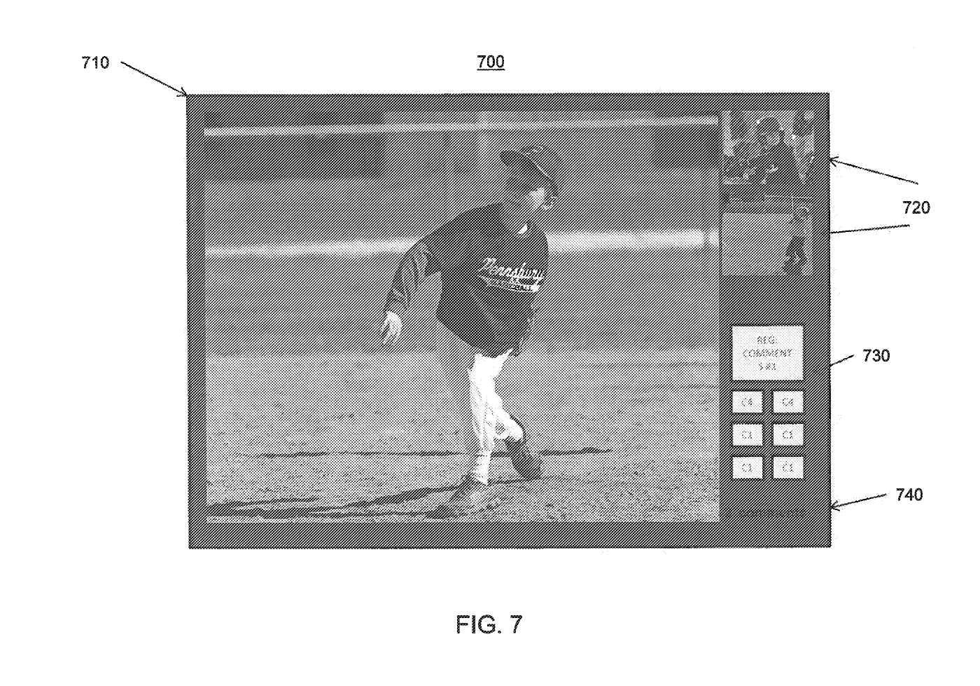

Referring now to FIG. 7, a second exemplary display device having displaying media comments on media content 700 according to another aspect of the present invention is shown. In this exemplary embodiment, a display device 710 is shown, such as computer monitor or television which is capable of playing back video or other streaming media. For illustrative purposes, a frame of a video is shown. In this embodiment, comments may be placed outside of the media content, but displayed in a similar time fashion to those previously described embodiments. For example, while original media content is being played in a first window, video comments 720 may be simultaneously played in a sidebar, or the like, where the comments are viewable to the viewer, but do not cover a portion of the original media content. Additionally, text or audio comments 730 may be displayed alongside the original media content as well as an indicator to additional comments 740. Timing of the comments may be timed according to the commentator's instructions, as described previously, or may be displayed for the entire length of the original media content.

Comments are placed by a commentator at particular point in a video. The commentator may identify the object of interest in the video concerning the comment. For example, the commentator may indicate in this exemplary embodiment that a pitcher's throwing form is good. Analysis of this text may be used to determine that that portion of the original media content concerns baseball, or more specifically, concerns throwing a baseball. Analysis of the text can yield sentiment data about the video. For example, favorable parts and sections of a video may be determined from favorable comments, and unfavorable portions of the video may be determined from unfavorable comments. Thus, a content provider may wish to generate previews or advertisements of the original media content based on parts of the original media content associated with positive comments.

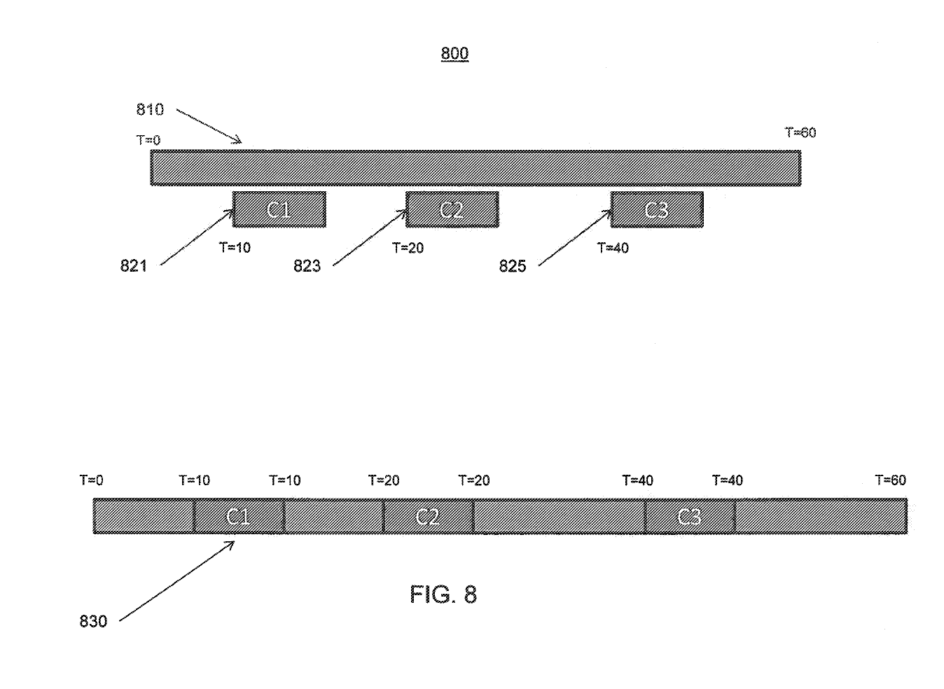

Referring now to FIG. 8, exemplary playback timelines 700 of media content playback are show according to the present invention. The original media content timeline 810 is shown, running uninterrupted from for 60 seconds, from T-0 seconds to T=60 seconds. Media comments 821, 823, 825 are represented under the timeline showing a start time and a duration. The start time, such as T=10 seconds for comment C1 821 is chosen by the commentator and the duration of the comment may be of a default duration, such as 10 seconds, or may be optionally chosen by the commentator in response to the original media content. Likewise comment C2 823 has a chosen start time of T=20 seconds and comment C3 825 has a chosen start time of T=40 seconds. The upper timeline 810 shows the running time of the original content and the time when comments C1, C2, and C3 821, 823, 825 will be displayed.

Optionally, a viewer may opt to display some comments integrated into the playback of the original content. The integrated media timeline 830 shows the playback timeline of the original media content with the comments C1, C2, and C3 integrated into the playback. Thus, in this exemplary embodiment, a viewer may watch the first 10 seconds of the original content, then media comment C1 is displayed to the viewer. After comment C1 has finished, playback of the original media content is resumed for another 10 seconds. Media comment C2 is then displayed to the viewer. When media comment C2 is completed, playback of the original media content is resumed for another 20 seconds and then media comment C3 is played. After media comment C3 is concluded, the remainder of the original media content is resumed for another 20 seconds.

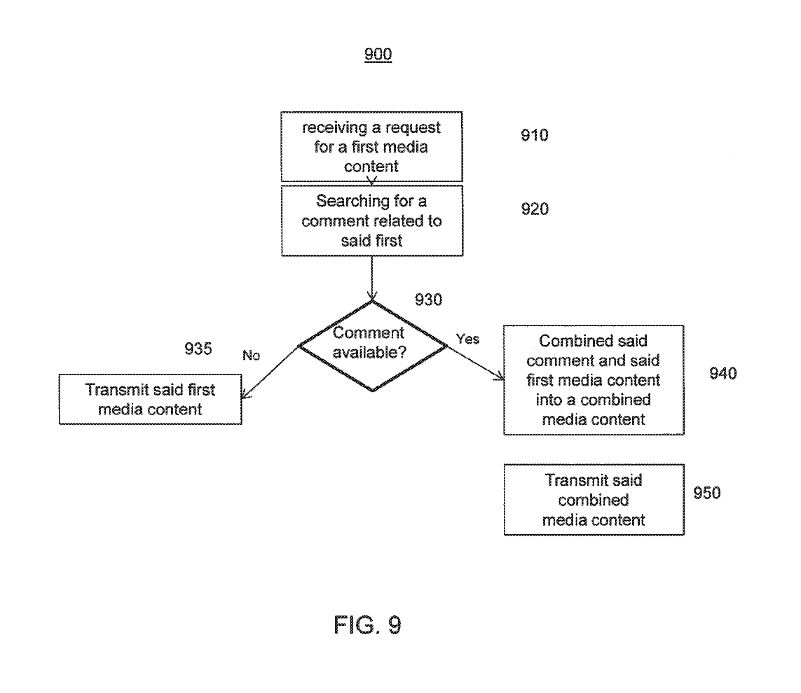

Referring now to FIG. 9, an exemplary process for generating media comments in media content 900 in accordance with the present disclosure is shown. The exemplary processes may be performed by a server on a IP network, a head end in a cable, satellite, cellular or fiber transmitting network, or at a broadcast signal provider. The system is operative to deliver a combined media file having both media content and comments arranged in a manner described previous.

The process is first operative to receive a request for a first media content 910. The first media content may be a video file, an audio file, or a multimedia presentation. The request may be received over a mobile network, the internet, through broadcast channels or the like. The request may be generated in response to a user input where a user requests to view the first media content.

Once receiving the request for the first media content, the system first determines if the first media content is available. Once the determination is made that the first media content is available, the system searches for comments related to the first media content 920. These comments may have been generated by commentators who have previously viewed the content. The comments may be text, audio files, video files, or multimedia presentations. If the system determines that a comment exists 930, the comment, or comments, are combined with the first media content and transmitted to the requesting device 950. The comments and the first media content are combined partially in response to metadata stored with the content, such as start time, location, etc. If no comments are found, the system transmits the first media content to the requesting device 935.

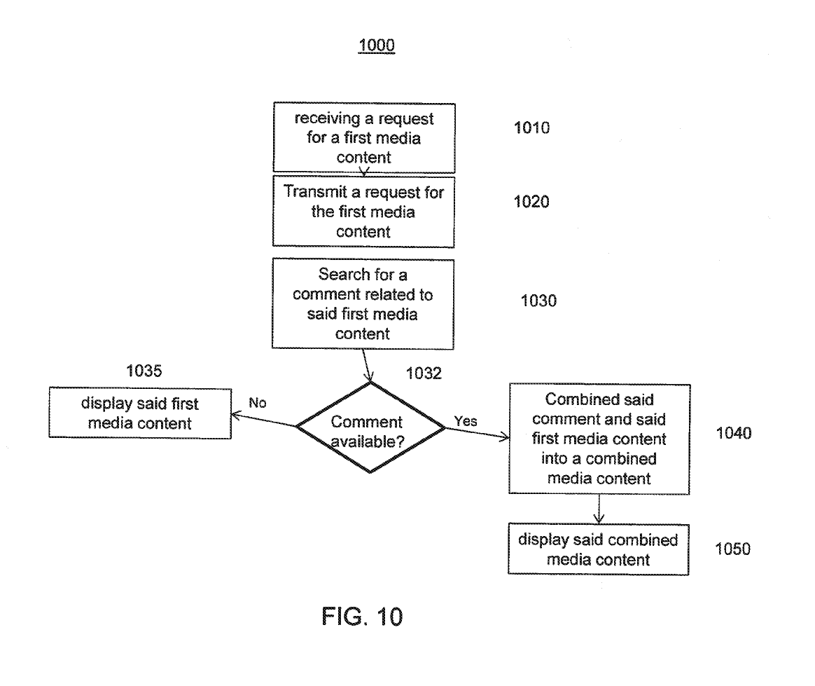

Referring now to FIG. 10, a second exemplary process for generating media comments in media content 1000 in accordance with the present disclosure is shown. The exemplary processes may be performed by a server on television receiver, a computer, a tablet, mobile device or any other media player connected via a network, such as a cellular, television, cable, fiber, or broadcast network with two way communication. The system is operative to generate a combined media file having both media content and comments arranged in a manner described previous.

The system is operative to receive a request for a first media content in response to a user input 1010. This user input may be received via a touch screen, a button, keyboard, or other user interface. In response to the request, the system transmits a request to a server or the like for the first media content 1020. The system is equipped to receive and store the first media content. The system then searches a database or the like, for comments relate to said first media content 1030. This search may be performed by searching a local memory, a local database, a remote database, or remote data storage host. The search may alternatively be performed by requesting the comments from a remote device, wherein the remote device searches for the comments and provides at least one comment if any comments are available. The system is further operative to request and receive any comments related to the first media content and to store the comments in a memory.

If the system determines that comments are available 1032, it requests the comments via a network from a data server or the like. The system then combines the first media content and at least one comment into a combined media content 1040. A signal is then generated by the system suitable for display 1050 containing the combined media content. The system may be operative to display the combined media content, or the combined media content may be transmitted to another device for display to a user. If no comments are available 1032, then the device is operative to generate a signal containing the first media content. The system may be operative to display the first media content, or the first media content may be transmitted to another device for display to a user. Additionally, the system may combine multiple comments and the first media content into a single combined media content.

It should be understood that the elements shown and discussed above, may be implemented in various forms of hardware, software or combinations thereof. Preferably, these elements are implemented in a combination of hardware and software on one or more appropriately programmed general-purpose devices, which may include a processor, memory and input/output interfaces. The present description illustrates the principles of the present disclosure. It will thus be appreciated that those skilled in the art will be able to devise various arrangements that, although not explicitly described or shown herein, embody the principles of the disclosure and are included within its scope. All examples and conditional language recited herein are intended for informational purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that the block diagrams presented herewith represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

1. A method of comprising the steps of:
receiving a request for a first media content;
searching for a first comment related to said first media content;
combining said first media content and said first comment into a combined media content; and
transmitting said combined media content.

2. The method of claim 1 wherein said first comment is a second media content and said combined media content includes said second media content displayed simultaneously over said first media content.

3. The method of claim 1 wherein said first comment includes metadata including a start time and a duration wherein said start time coincides with a time within said first media content.

4. The method of claim 1 wherein said first comment is displayed at a time and for a duration determined by a commentator generating said comment.

5. The method of claim 1 further comprising a second comment wherein said first comment is displayed larger than said second comment in response a first relationship between a first commentator generating said first comment and a user generating said first media content and a second relationship between a second commentator generating said second comment and said user generating said first media content.

6. The method of claim 1 wherein said first comment is displayed as a link within said combined media content and wherein said link connects to a second media content related to said first media content.

7. The method of claim 1 wherein said first comment is an audio content and wherein said audio content is played in place of an audio portion of said first media content.

8. The method of claim 1 wherein said first comment is displayed as an image within said combined media content and wherein said image includes a hyperlink to a second media content related to said first media content.

9. The method of claim 1 further comprising a second comment wherein said first comment is displayed as an image and said second comment is displayed as a text string.

10. The method of claim 1 wherein a location of said first comment within said combined media content is determined in response to a user input.

11. A method of comprising the steps of:
generating a request for a first media content in response to a user input;
receiving said first media content;
searching for a first comment, wherein said first comment is related to said first media content;
receiving said first comment;
combining said first media content and said first comment into a combined media content; and
generating a signal containing said combined media content.

12. The method of claim 11 wherein said first comment is a second media content and said combined media content includes said second media content played simultaneously over said first media content.

13. The method of claim 11 wherein said first comment includes metadata including a start time and a duration wherein said start time coincides with a time within said first media content.

14. The method of claim 11 wherein said first comment is displayed at a time and for a duration determined by a commentator generating said comment.

15. The method of claim 11 further comprising a second comment wherein said first comment is portrayed larger than said second comment in response a first relationship between a first commentator generating said first comment and a user generating said first media content and a second relationship between a second commentator generating said second comment and said user generating said first media content.

16. The method of claim 11 wherein said first comment is depicted as a link within said combined media content and wherein said link connects to a second media content related to said first media content.

17. The method of claim 11 wherein said first comment is an audio content and wherein said audio content is played in place of an audio portion of said first media content.

18. The method of claim 11 wherein said first comment is displayed as an image within said combined media content and wherein said image includes a hyperlink to a second media content related to said first media content.

19. The method of claim 11 further comprising a second comment wherein said first comment is portrayed as an image and said second comment is portrayed as a text string.

20. The method of claim 11 wherein a location of said first comment within said combined media content is determined in response to a user input.

21. An apparatus comprising:
an input for receiving a request for a first media content;
a memory for storing a first comment related to said first media content;
a processor operative to determine a relationship between said first media content and said first content, for combining said first media content and said first comment into a combined media content; and
a transmitter for transmitting said combined media content.

22. The apparatus of claim 21 wherein said first comment is a second media content and said combined media content includes said second media content portrayed simultaneously over said first media content.

23. The apparatus of claim 21 wherein said first comment includes metadata including a start time and a duration wherein said start time coincides with a time within said first media content.

24. The apparatus of claim 21 wherein said first comment is portrayed at a time and for a duration determined by a commentator generating said comment.

25. The apparatus of claim 21 wherein said memory is further operative to store a second comment, and wherein said processor is further operative to combine said second comment into said combined media content, and wherein said first comment is portrayed larger than said second comment in response a first relationship between a first commentator generating said first comment and a user generating said first media content and a second relationship between a second commentator generating said second comment and said user generating said first media content.

26. The apparatus of claim 21 wherein said first comment is portrayed as a link within said combined media content and wherein said link connects to a second media content related to said first media content.

27. The apparatus of claim 21 wherein said first comment is an audio content and wherein said audio content is played in place of an audio portion of said first media content.

28. The apparatus of claim 21 wherein said first comment is portrayed as an image within said combined media content and wherein said image can be selected in order to generate a request for a second media content related to said first media content.

29. The apparatus of claim 21 further comprising a second comment wherein said first comment is displayed as an image and said second comment is displayed as a text string.

30. The apparatus of claim 21 wherein a location of said first comment within said combined media content is determined in response to a user input.

31. A apparatus comprising:
an interface for generating a control signal in response to a user input;
a processor for generating a request for a first media content in response to a user input, generating a request for a first comment, wherein said first comment is related to said first media content, and for combining said first media content and said first comment into a combined media content, said processor further operative to generating a signal containing said combined media content;
a transmitter for transmitting said request for said first media content and said request for said first comment; and
an input for receiving said first media content and said first comment.

32. The apparatus of claim 31 further comprising a display for displaying said combined media content.

33. The apparatus of claim 31 wherein said first comment is a second media content and said combined media content includes said second media content played simultaneously over said first media content.

34. The apparatus of claim 31 wherein said first comment includes metadata including a start time and a duration wherein said start time coincides with a time within said first media content.

35. The apparatus of claim 31 wherein said first comment is displayed at a time and for a duration determined by a commentator generating said comment.

36. The apparatus of claim 31 further comprising a second comment wherein said first comment is portrayed larger than said second comment in response a first relationship between a first commentator generating said first comment and a user generating said first media content and a second relationship between a second commentator generating said second comment and said user generating said first media content.

37. The apparatus of claim 31 wherein said first comment is depicted as a link within said combined media content and wherein said link connects to a second media content related to said first media content.

38. The apparatus of claim 31 wherein said first comment is an audio content and wherein said audio content is played in place of an audio portion of said first media content.

39. The apparatus of claim 31 wherein said first comment is displayed as an image within said combined media content and wherein said image includes a hyperlink to a second media content related to said first media content.

40. The apparatus of claim 31 further comprising a second comment wherein said first comment is portrayed as an image and said second comment is portrayed as a text string.

41. The apparatus of claim 31 wherein a location of said first comment within said combined media content is determined in response to a user input.
